(19) United States
(12) Patent Application Publication
(10) Pub. No.: US 2005/0211316 A1
(43) Pub. Date: Sep. 29, 2005

(54) Electromagnetic valve

(76) Inventors: Hubert Ott, Ravensburg (DE); Thomas Grau, Argenbuehl (DE)

Correspondence Address: Breneman & Georges, 3150 Commonwealth Avenue, Alexandria, VA, 22305, US

(21) Appl. No.: 10/505,357

(22) PCT Filed: Feb. 19, 2003
(86) PCT No.: PCT/DE03/00515

§ 371 Date: Nov. 18, 2004

(30) Foreign Application Priority Data
Feb. 19, 2002 (DE) 102-06-778.3

(51) Int. Cl. F15B 13/044

(52) U.S. Cl. 137/625.65

(57) ABSTRACT

An electromagnetic valve is provided that has a compact structural design and has especially low-noise characteristics. This is achieved in a valve with two pole pieces, wherein at least one pole piece is provided with a fluid line and a valve seat, and wherein the fluid line is connected by the valve seat with a valve chamber, in which a valve body is arranged so that it can move between at least two switch settings between the valve seat and at least one other stop surface, which operates at especially low noise levels. This is achieved according to the invention by providing at least one guide piece (15) incorporated in the valve housing to linearly guide the valve body in an axial direction.

### CROSS REFERENCE TO RELATED APPLICATIONS

The subject matter of this application is related to U.S. application Ser. No. 10/505,354 filed Aug. 19, 2004.

### STATEMENT REGARDING FEDERALLY SPONSORED RESEARCH OR DEVELOPMENT

Not applicable.

### INCORPORATION-BY-REFERENCE OF MATERIAL SUBMITTED ON COMPACT DISC

Not applicable.

### REFERENCE TO A “MICROFICHE APPENDIX”

Not applicable.

### BACKGROUND OF THE INVENTION

(1) Field of the Invention

The invention relates to an electromagnetic valve having two pole pieces wherein at least one pole piece includes a fluid line and a valve seat in which the fluid line is connected by the valve seat with a valve chamber in which the valve body can move between at least two switch settings. More particularly the invention has at least one guide piece (15) in the valve housing to linearly guide the valve body (9) in an axial direction between switch settings.

(2) Description Of Related Art Including Information Disclosed Under 37 CFR 1.97 and 1.98

Electromagnetic, in particular bistable, valves are used in a variety of applications, e.g., in fluid circulating systems of household appliances, such as refrigerators and coffeemakers, but also in other areas, e.g., in the area of analytics or medical technology.

In most areas of application, e.g., that of household appliances, preference is here given to valves that have a compact design, and can also be manufactured and assembled with the least possible effort. Various developments have very recently become known for meeting this objective (see DE 199 14 972 A1).

### BRIEF SUMMARY OF THE INVENTION

Proceeding from valves according to this prior art, the object of the invention is to provide a valve that has particularly low noise characteristics.

The advantages of the invention are achieved by utilizing an electromagnetic valve having two pole pieces in which at least one pole piece includes a fluid line and a valve seat in which the fluid line is connected by the valve seat with a valve chamber in which the valve body can move between at least two switch settings wherein the invention has at least one guide piece (15) in the valve housing to linearly guide the valve body (9) in an axial direction between switch settings.

Additional advantages of the invention include utilizing guide elements (23) in the guide piece (15) designing the guide elements (23) as inner, radial ribs on the guide sleeve (15) providing a fluid passage in the guide piece (15). Constructing at least part of the guide piece (15) from plastic, providing at least one spacer element in the valve chamber (24) constructing the spacer element in a sleeve shape, employing the guide element (15) as a spacer element, adding a filter element (16) to the guide element, providing a second fluid line (10) as an eccentric hole in a pole piece, providing a tubular housing for the pole pieces (3, 4) and the guide piece (15), providing at least one permanent magnet (13, 14), arranging the at least one permanent magnet inside the tubular valve housing, utilizing an annular magnet, placing the permanent magnet on a projection (11, 12), providing a receptacle in the guide piece (15) for a permanent magnet having elevations in the receptacle for positive connection between the guide piece and at least one permanent magnet, providing deformable elevations, providing elastic elevations, incorporating the tubular valve housing (2) in a control coil (21), employing a ball and at least partially spherical valve seat, providing outer connecting tubes (18, 19) secured to at least one pole piece and providing a third fluid line (6) and second valve seat (8) to create a 3/2 valve.

Accordingly, a valve according to the invention is characterized in that at least one guide piece incorporated in the valve housing is provided to linearly guide the valve body in an axial direction. An eccentric collision by the valve body with the valve seat had previously been possible, e.g., caused by the fluid, resulting in an elevated wear and increased noise generation. The guide according to the invention now ensures that the entire movement of the valve body is centered and axially parallel. As a result, the valve body is also placed centrally on the valve seat, eliminating the necessity for centering given an impact on the valve seat. This yields a lower noise level and reduced wear.

The guide piece is preferably designed as a guide sleeve. A sleeve-shaped guide piece results in a circumferentially good guide on the outer wall of the valve chamber. A sleeve-shaped guide piece is hence effectively fixed in a radial direction after inserted, correspondingly adjusted in the radial direction to the inner contour of the valve chamber. In addition, the sleeve-shaped guide piece makes it possible to uniformly guide the valve body on the inner circumference of the guide piece. Such a guide piece can be used to largely preclude a twisting or jamming of the valve body.

In a special embodiment of the invention, in particular in a sleeve-shaped guide piece, the guide elements are designed as inner, radially protruding ribs. Such guide elements can already be molded into the guide piece during its manufacture, thereby eliminating the need for additional structural elements or additional processing steps. This significantly reduces the production effort for the guide piece. Further, such guide ribs make it possible to axially guide the valve body over its entire moving length as desired, simultaneously enabling a passage between such ribs for the fluid, and hence a connection between the two fluid lines, without allowing any impairment by the guide piece.

The guide piece according to the invention can advantageously be made out of plastic, e.g., via injection molding. This makes the production effort exceedingly low, wherein the valve can conceivably also easily be used for chemically aggressive fluids or under a thermal load through the suitable selection of materials for the guide piece.

In a special embodiment, a spacer element is also provided, which fixes the distance of the structural elements exhibiting the stop surfaces for the end positions of the valve body or a valve seat, e.g., the pole pieces. This distance is of great importance for the functionality of the valve. The precise location of the end positions of the valve body in its various switch settings is important for many valve properties. For example, the starting force of the valve body on the valve seat depends on the location of the valve seat relative to the shape and strength of the magnetic field that holds the valve body on the valve seat.

In addition, the distance of the stop surfaces of the valve body in its different switch settings is important, since this influences the acceleration distance, and hence the impact pulse, of the valve body. Accordingly, distance fluctuations can be manifested as differences in noise generation and signs of wear on the valve.

The distance in question is also crucial in terms of the free flow cross section with the valve opened.

A significant production effort has to date been required for keeping allowable tolerances as low as possible with respect to this distance during valve assembly.

Valve assembly is greatly facilitated by the invention through the use of a spacer element placed between the structural elements exhibiting the stop surfaces or valve seat for the valve body, e.g., between the two pole pieces in the area of the valve chamber. The two pole pieces or the structural elements having stop surfaces or the valve seat for the valve body can be joined at the stop using the spacer element, yielding a clearly defined position relative to each other. The tolerance when establishing this distance corresponds to the dimensional tolerance of the spacer element.

The guide piece is preferably designed in such a way as to ensure fluid flow. This ensures a free fluid flow through the valve chamber via the valve seat into a first fluid line serving as the outlet. With the valve open, the passage through the spacer element establishes the connection between this fluid line and a second fluid line correspondingly serving as the inlet line.

Both the first and second fluid lines are preferably incorporated in the two pole pieces as holes, thereby eliminating additional complicated design measures here as well.

In a special embodiment of the invention, the spacer element is designed as a sleeve. This yields a symmetrical stop surface for the structural elements to be joined, e.g., the pole pieces.

The guide piece is simultaneously preferably provided as a spacer element, thereby reducing the number of required parts, and hence manufacturing effort. This is easily possible in particular given a guide piece or spacer element with a sleeve-shaped design.

In a special embodiment of the invention, the guide piece is provided with a filter element. Such a filter element, e.g., designed as a sieve insert, makes it possible to keep dirt particles out of the valve seat and valve body area. This ensures a durable sealing function and compressive strength on the one hand, and a lower wear, and hence increased valve life on the other.

This embodiment is particularly advantageous when used in closed fluid circulating systems, in which the fluid in the closed circulating system is filtered through completely one time, after which dirt loads that can jam the filter element no longer arise. In this embodiment, the filter element must be dimensioned in such a way that it can filter out all dirt particles that might come about during valve assembly or other production processes without significantly impairing filter permeability.

Valve inflow is preferably realized with an eccentrically arranged hole in a pole piece, thereby simultaneously enabling the series-connection of the filter element in proximity to the outer circumference of the valve chamber. In this case, the filter or sieve element can be disk-shaped, e.g., as a ring wheel.

In addition, the valve housing is advantageously designed as a tube, which is to incorporate all essential valve components. In a particularly simple embodiment of the invention, these valve elements are limited to the pole pieces, the spacer element, if necessary with filter, and the valve body.

Such a tube, preferably in the form of a cylindrical tube, can be obtained by simply cutting to length a commercially available tube material, e.g., made of stainless steel, and additionally offers the advantage that it can be inserted into a control coil without any problem due to its cylindrical form.

In order to tightly seal the valve chamber, it is best that the pole pieces be connected with the cylindrical tube after inserted therein, preferably welded, for example in the case of a stainless steel tube. A very tight weld can be established from outside via laser welding. However, other joining methods, e.g., press molding or the like, are also conceivable at this juncture.

A valve according to the invention is preferably designed as a bistable valve, for which at least one permanent magnet, two permanent magnets in the preferred embodiment, are to be provided to hold the valve body in its respectively actuated switch setting via the permanent magnetic field. Both for this purpose and to effect control via an electromagnetic control coil, the valve body is best made at least partially out of magnetic or magnetizable material.

The permanent magnet(s) is/are preferably designed as annular magnets that generate a circumferentially uniformly distributed, rotationally symmetrical magnetic field, and additionally are easy to place in or on a receptacle of correspondingly cylindrical design.

In one special embodiment, each pole piece is for this purpose provided with a corresponding cylindrical projection, onto which an annular magnet can be slipped. This provides for a radial fixation of the permanent magnets. Axial fixation can be initiated by appropriately designing the spacer element or its guide elements, thereby making the overall assembly of even a bistable valve particularly simple. In the described further development of the invention, only the pole pieces, valve body, guide piece, if necessary with integrated filter, and permanent magnets need be inserted into a cylindrical tube and fixed in place by attaching the pole pieces, e.g., by welding. The unit fabricated in this way can then be inserted as a complete valve unit into a control coil, thereby providing the desired compact overall unit.

The permanent magnets are preferably fixed in place by providing corresponding receptacles in the spacer element to bring about the desired defined position of the permanent magnets by way of a positive connection with the permanent magnets. In a special embodiment, such a receptacle can be provided, for example, in the form of pin or cone-shaped elevations, which ensure a positive connection with the permanent magnets. In addition, the positive connection can be improved by making such a receptacle deformable, in particularly elastically deformable, in design.

Since a partially spherical shape has proven itself for the valve body or valve seat, the preferred embodiment of the invention makes use of a valve body encompassing a ball whose diameter is tailored to a spherical valve seat. Already at a low height of lift for the valve body, the spherical shape of the valve seat and ball already yield an opening gap with a comparatively large cross section.

In a particularly advantageous further development of this embodiment, the selected valve body itself is a ball, preferably a steel ball. This embodiment offers the advantage of a valve body with optimal fit on a spherical valve seat at a very low mass. The low mass ensures a reduced pulse acting on the valve seat while switching the valve, and hence lower wear and less noise generation.

A valve according to the invention can be designed as a so-called 2/2 valve, wherein the described two fluid lines are provided in this case. The two switching states of the valve here define an open valve state, in which the valve body is lifted from the valve seat, thereby interconnecting the two fluid lines. By contrast, in the closed valve state, the valve body sits on the valve seat, thereby interrupting the fluid connection.

A valve according to the invention can also be designed as a 3/2 valve. In this case, a third fluid line and second valve seat must be provided.

In this case, the two outflow lines are preferably attached in the pole pieces via centric holes, wherein a respective valve seat is secured to the pole piece, preferably molded therein, on the side facing the valve body. The centric arrangement of outflow lines permits the centered position of the valve body, and hence a uniform, rotationally symmetrical exposure to annular magnets on the one hand, and the outlying control coil on the other.

In a particularly advantageous embodiment, the external connection of the two fluid lines is established by using conduits at the outlet end of the holes in the pole pieces serving as a fluid line and connecting them there, e.g., via soldering.

### BRIEF DESCRIPTION OF THE SEVERAL VIEWS OF THE DRAWING(S)

An exemplary embodiment of the invention is shown in the drawing, and will be explained in greater detail below based on the figures.

Shown on:

FIG. 1 is a longitudinal section through a 3/2 valve according to the invention, and

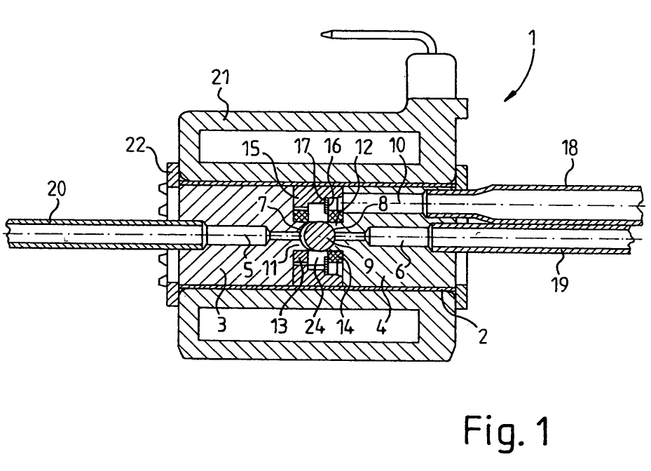

FIG. 2 is a perspective view of a guide piece according to the invention.

### DETAILED DESCRIPTION OF THE INVENTION INCLUDING BEST MODE

Valve 1 encompasses a valve housing 2 designed as a cylindrical tube, into which two pole pieces 3, 4 are inserted. A respective hole 5, 6, each serving as a fluid line, is introduced in pole pieces 3, 4. Fluid lines 5, 6 empty into two valve seats 7, 8, which are spherical, and hence tailored to the shape of a ball-shaped valve body 9. In the switching state shown, valve body 9 closes valve seat 8.

In addition to centric hole 6, pole piece 4 also accommodates another eccentric hole 10, which serves as an inlet for the fluid.

The two pole pieces 3, 4 are provided with cylindrical projections 11, 12 in the form of cross sectionally tapered segments, upon which the two annular magnets 13, 14 are placed. Annular magnets 13, 14 establish a roughly flush seal with pole pieces 3,4 or valve seats 7, 8.

A guide sleeve 15 according to the invention is inserted between the pole pieces. It simultaneously serves as a spacer element, and thereby precisely defines the distance between pole pieces 3, 4 or valve seats 7, 8, and hence the free flow cross section with the valve opened. A sieve 16 is designed as a ring wheel, and placed inside guide sleeve 15, which is provided with a shoulder 17 for this purpose.

Pole pieces 3, 4 are connected with valve housing 2 in a manner not shown in any greater detail, welded in the stainless steel version, preferably laser-welded from outside.

Connecting tubes 18, 19, 20 are inserted in holes 5, 6 and 10, which are widened somewhat at the end for this purpose. Connecting tubes 18, 19, 20 are tightly connected with pole pieces 3, 4, e.g., soldered.

The entire valve is placed in a control coil 21, and fixed on the end via a yoke plate 22, which can be a box-type yoke or U-shaped, by abutting valve housing 2 and parts of pole pieces 3, 4 with yoke plate 22.

The valve is conceptually simple to assemble. The different valve components, i.e., pole pieces 3, 4, valve body 9 with annular magnets 13, 14 secured thereto, and spacer sleeve 15 are positively introduced into the housing and welded therein. Connecting tubes 18, 19, 20 are preferably secured in pole pieces 3, 4 prior to welding. As a result, the valve is completed, and its assembly only involves placing it in control coil 21, and fixing it in place with yoke plate 22.

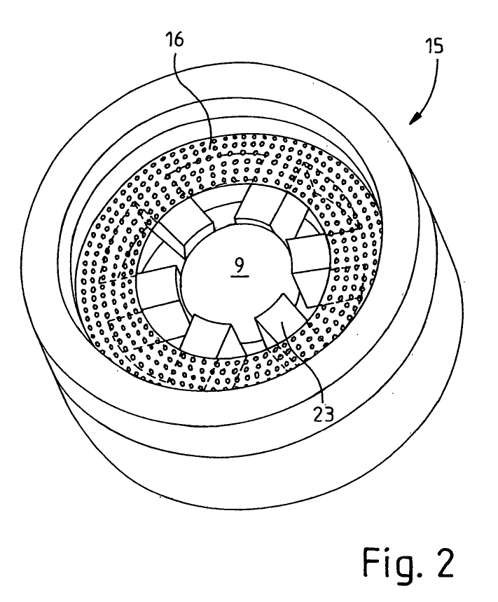

The perspective view of spacer sleeve 15 with incorporated valve body 9 according to FIG. 2 depicts guide ribs 23, which protrude radially inward, and guide the ball that forms valve body 9 along the valve axis in its linear movement. Also visible in this view is sieve 16, which is placed in spacer sleeve 15. Guide ribs 23 simultaneously form a passage for the fluid streaming from the eccentric hole 10 serving as an inlet in pole piece 4 into valve chamber 24, which incorporates valve body 9. As a result, guide ribs 23 also ensure passage to outlets 5, 6 via valve seats 7, 8, depending on the switch setting of the valve. In this case, annular magnet 14 internally seals off the inlet 10 in the area of sieve 16, thereby ensuring that the fluid must pass through sieve 16 from hole 10 to get inside valve chamber 24.

The guide sleeve 15 carrying sieve 16 is used for precisely setting the distance of pole pieces 3, 4 or their valve seats 7, 8 on the one hand, and ensures that ball-shaped valve body 9 is axially well guided via guide ribs 23. Use of guide sleeve 15 that also serves as a spacer element greatly facilitates assembly. Guide ribs 23 reduce the noise level during valve operation.

In addition, due to the ball-shaped design of valve body 9 and corresponding spherical shape of valve seats 7, 8, this embodiment requires only a slight switching path of valve body 9 to generate a gap between valve seat 7 or 8 and valve body 9, which provides a sufficient flow cross section.

The short switching paths of valve body 9 in turn reduce noise generation. Securing the annular magnets in direct proximity to the valve seat permits smaller dimensions for the latter, while still generating a sufficiently high contact force of valve body 9 on the respective valve seat 7, 8.

The ball shape additionally enables the use of a valve body 9 with a very low mass, thereby distinctly reducing noise generation and wear during impact on the respective valve seat 7, 8. This also facilitates the manufacture of valve seats 7, 8, since the latter can have a lower hardness. In addition, inexpensive steel balls of sufficient quality are available on the market.

Sieve 16 ensures that no dirt particles can get in the area of valve seats 7, 8, resulting in improved sealing function and reducing wear. In addition, magnetic or magnetizable particles from the streaming fluid are also retained on the permanent magnet 14 positioned in the flow.

Annular magnets 13, 14 yield a valve with a bistable design. Suitable permanent magnets can be used to fabricate valves with enough chemical and thermal resistance to enable operation even under severe conditions, e.g., at high temperatures or with chemically aggressive fluids. In this bistable embodiment, the switch position can be changed with only a short control pulse via control coil 21 to change the switch setting, so that valve 1 as a whole not only forms a compact valve unit that can be manufactured at low cost, but also yields very high energy savings.

### REFERENCE LIST

1 Valve
2 Valve housing
3 Pole piece
4 Pole piece
5 Hole
6 Hole
7 Valve seat
8 Valve seat
9 Valve body
10 Hole
11 Projection
12 Projection
13 Annular magnet
14 Annular magnet
15 Guide sleeve
16 Sieve
17 Shoulder
18 Connecting tube
19 Connecting tube
20 Connecting tube
21 Control coil
22 Yoke plate
23 Guide ribs
24 Valve chamber

1. A valve with two pole pieces, wherein at least one pole piece includes a fluid line and a valve seat, and wherein the fluid line is connected by the valve seat with a valve chamber, in which a valve body can move between at least two switch settings, wherein the improvement comprises at least one guide piece (15) disposed in a valve housing to linearly guide the valve body (9) in an axial direction between the switch settings.

2. The valve according to claim 1 wherein said at least one guide piece is a guide sleeve (15) with guide elements (23).

3. The valve according to claim 2 wherein said guide elements (23) include inner, radial ribs disposed on the guide sleeve (15)

4. The valve according to claim 1 wherein said guide piece (15) has a fluid passage.

5. The valve according to claim 1 wherein said guide piece (15) is made at least partially of plastic.

6. The valve according to claim 1 wherein said guide piece (15) is a spacer element (15) in the area of the valve chamber (24) for setting the distance of the valve seat (7) from another stop surface (8) for the valve body (5)

7. The valve according to claim 6 wherein said spacer element (15) is sleeve-shaped.

8. The valve according to claim 1 wherein said guide piece (15) is a spacer element.

9. The valve according to claim 1 or 2 wherein said guide piece (15) includes a filter element (16).

10. The valve according to claim 1 further comprising a second fluid line (10) radially disposed from said fluid line as an eccentric hole in a pole piece (4).

11. The valve according to claim 1 wherein the two pole pieces (3, 4) and guide piece (15) are disposed in a tubular valve housing (2).

12. The valve according to claim 1 further comprising at least one permanent magnet (13, 14).

13. The valve according to claim 12 wherein said at least one permanent magnet (13, 14) is disposed inside the tubular valve housing (2).

14. The valve according to claim 12 wherein said at least one permanent magnet (13, 14) is an annular magnet.

15. The valve according to claim 12 wherein said at least one permanent magnet (13, 14) is disposed on a projection (11, 12) of a pole piece (3, 4) formed by a cross sectionally tapered segment.

16. The valve according to claim 1 wherein said guide piece (15) includes a receptacle for a permanent magnet (13, 14).

17. The valve according to claim 16, wherein said receptacle includes elevations to provide a positive connection between the guide piece (15) and at least one permanent magnet.

18. The valve according to claim 17 wherein said elevations are deformable.

19. The valve according to claim 17 wherein said elevations are elastic.

20. The valve according to claim 1 wherein said pole pieces, said valve seat, said valve chamber, said valve body and said at least one guide piece is disposed in a tubular valve housing (2) and said tubular valve housing is disposed in a control coil (21).

21. The valve according to claim 1 wherein said valve body (9) is a ball, and the valve seat (7, 8) is at least partially spherical.

22. The valve according to claim 1 wherein said valve body (9) is a ball.

23. The valve according to claim 1 further comprising outer connecting tubes (18, 19, 20) secured in at least one pole piece (3, 4) to carry fluid.

24. The valve according to claim 1 further comprising additional fluid lines and a second valve seat (8) to create a 3/2 valve.

25. A valve with two pole pieces, wherein at least one pole piece includes a fluid line and a valve seat, and wherein the fluid line is connected by the valve seat with a valve chamber, in which a valve body can be moved between at least two switch settings, wherein the improvement comprises at least one guide piece (15) incorporated in the valve housing to linearly guide the valve body (9) in an axial direction between the switch settings, and wherein the pole pieces (3, 4) and guide piece (15) are disposed in a tubular valve housing (2).

26. An electromagnetic valve article of manufacture comprising:
(a) a control coil housing having a first end and a second end;
(b) a first substantially cylindrical pole piece having a first end and a second end disposed within said control coil housing said first end extending to about said first end of said control coil housing;
(c) a second substantially cylindrical pole piece having a first end and a second end disposed within said control coil housing said first end extending to about said second end of said control coil housing;
(d) a first permanent magnet disposed at about the second end of said first substantially cylindrical pole piece;
(e) a second permanent magnet disposed at about the second end of said second substantially cylindrical pole piece;
(f) a valve housing disposed intermediate said first permanent magnet and said second permanent magnet; and
(g) a guide element having an opening therein disposed between said second end of said first substantially cylindrical pole piece and said second end of said first substantially cylindrical pole piece and fixing the size of said valve housing.
